(19) United States
(12) Patent Application Publication
(10) Pub. No.: US 2002/0010636 A1
(43) Pub. Date: Jan. 24, 2002

(54) Incentive system for use with a system using a network to facilitate transactions between a buyer and at least one seller

(76) Inventor: John J. Immel, Cambridge, MA (US)

Correspondence Address: FOLEY, HOAG & ELIOT, LLP, PATENT GROUP, ONE POST OFFICE SQUARE, BOSTON, MA, 02109, US

(21) Appl. No.: 09/778,584

(22) Filed: Feb. 7, 2001

Related U.S. Application Data
(63) Continuation-in-part of application No. 09/619,852, filed on Jul. 20, 2000.

(51) Int. Cl. G06F 17/60

(52) U.S. Cl. 705/26

(57) ABSTRACT

A system of connecting buyers and sellers via a network where neither party needs to incur significant search costs to locate the other, and the search requirement of connecting a buyer and a seller can be decreased, eliminated, or automated. It is further desired that transactions for personal goods or services can have their search costs lowered. It is still further desired that such systems could allow a transaction to be flexible in both costs and goods or services provided and that the system be capable of allowing a novice buyer to find goods or services with a lessened concern of being taken advantage of because they can use the system's expertise, instead of their own, in locating sellers. It is also desired that this system have some type of incentive system for encouraging the parties involved in a transaction to report information on that transaction back to the operator of the system so the operator can gather information about the types of transactions occurring, rating the buyers or sellers using the system, or to insure the system operator is compensated for his services.

### RELATED U.S. APPLICATIONS

This patent is a continuation in part of U.S. Pat. Ser. No. 09/619,852 filed Jul. 20, 2000 the entire disclosure of which is herein incorporated by reference.

### BACKGROUND OF THE INVENTION

1. Field of the Invention

This application relates to the field of sales of goods and services and more particularly to the field of rating sellers of goods and services to promote reporting by the seller of transactions.

2. Description of Related Art

There are many ways in which goods and services are transferred between a buyer and a seller. In traditional commerce, storefronts, mail-order, and direct sales methods are all common. In recent years, however, the Internet and other computer networks have become increasingly common in connecting sellers of goods and services with buyers desiring to purchase those same goods and services. Recently, many different methods for selling goods and services over computer networks have been developed. Among other problems, a significant problem with these methods is that one of the two parties to a transaction needs to spend time searching for the other party. This is a problem also present in conventional commerce.

Buyers would like to be contacted directly buy the sellers of goods or services they want and be able to quickly locate a seller of a desired good. At the same time, the buyer does not want to be contacted by sellers of goods or services he or she does not want. These desires are paralleled by the desires of a seller. They would like to be able to directly contact buyers interested in the purchase of their goods, at the same time they would prefer to avoid the expense and negative publicity from contacting those who are not interested.

In commerce it has previously been difficult for sellers to contact those interested in their products, and only those interested in their products. This desire has led to the use of a “target group” type of search. The target group system is not ideal, however. Sellers would like to have a method to be connected to all buyers interested in their good or service, and only those buyers interested in their good or service. Such a system would eliminate the search costs for the seller. The target group lowers the search cost for the seller (more of the target group is interested in the good or service) but sellers cannot single out a specific individual and know that that particular individual is interested in their good or service. Sellers also often pay a premium to be connected to these groups, for instance to advertise in a specific magazine, or to be in physical locations that are frequented by the target group, such as a shopping mall. Thus, the decreased scope of search is often buried by the increased cost of accessing the target group.

At the same time, the consumers are still forced to do some searching to find a desired good or service even if they are members of a target group. Buyers would like to be placed in contact with all sellers of a good or service when they are interested in that good or service and only when they are interested in that good or service. Instead buyers will be exposed to a wide selection of products many of which will not interest them at that time, and they will still have to spend at least some time searching for a specific product or service when they desire it. Such search could be looking for a specific item and having to find sellers that have not aimed for target groups they are part of, or having to search through the information they are presented with for the item they are searching for. Buyers would like a system where they can contact a seller to locate a good or service when they are interested in that good or service and have no contract with the seller when they are not.

The Internet has provided buyers and sellers a new way to conduct transactions, but as a place for commerce, buyers and sellers have followed many of the traditional models and have not improved the situation by decreasing search of both the buyer and the seller. The most common method for connecting buyers with sellers over the Internet is the Internet storefront. In this situation a seller creates a webpage where it can show items that are for sale. The seller may then advertise the webpage to encourage potential buyers to come and visit it and purchase items. This form of Internet commerce does not decrease the search since it operates in essentially the same way as non-Internet commerce. Although there have been improvements to a buyer's search resources (for instance via search engines), both parties must still engage in search before a transaction can be completed.

A second method which has arisen for connecting buyers with sellers over a network is the auction format. Although this format allows for less search, since a buyer can come to a single location to find a potential good, there are still significant search problems. A buyer knows what is generally available on the auction, but will not know if a particular auction server has a particular product on a particular day. This will require them to search multiple auctions on multiple days to locate their desired good or service. This is worse than having to search internet storefronts because the items on an auction can change significantly over time whereas those in a store front tend to remain constant. In addition, sellers still have to hope that buyers show up for their product. They have to post on a board without any knowledge that an individual interested in purchasing their product will show up looking for it, such lack of knowledge may result in their searching of different auction sites to find one that more likely has their target audience. Thus, the auction format has many of the same search problems as the storefront.

A third method for connecting buyers with sellers over the Internet is the classified “want ad.” In an Internet want ad, the buyer posts what they want to website classifieds and then waits for sellers to respond to the want ad. Although this avoids some of the search problems, it more reverses the search problems instead of solving them. In particular, the sellers still have to spend the time and effort coming to the classifieds to look for potential buyers without knowing if there is a want ad posted for the good or service they provide. The buyers also have to spend time searching for a classified area that is likely to be visited by a “target audience” of sellers who might have the good or service they are seeking. Thus, the want ad does not eliminate the search problems, but just reverses them.

In the market for personalized goods, the search costs increase and the situation worsens. If the Buyer is searching for a good or service only they would want, or one which is modified from a standard pattern, it is much harder to locate an appropriate seller. At the same time, sellers of personalized goods find it harder to generate a target group since they will not know the specifics of what a buyer wants in the personalized good or service. Thus, in an improved shopping world, a buyer would be able to decide they wanted a good or service, contact potential sellers who can supply the good or service they want, and then have a supplier supply that good or service. This way the buyers get what they want with little or no search cost, and the sellers are contacted by buyers seeking their goods or services without having to search them out.

When a system is generated that allows the connection of buyers and sellers over a network, one of the primary problems is insuring that the operator of the system on the network has a way to know what is transpiring over the system. In particular it can be difficult to insure that a buyer and seller, having located each other over the network, do not now carry out a transaction that does not involve the operator of the system, and which prevents the system owner from gaining any payment for his help in connecting the two parties. Such a system would be desirable for those involved in the connection of goods and services.

### SUMMARY OF THE INVENTION

Because of problems such as these, it is desired in the industry to create a system of connecting buyers and sellers via a network where neither party needs to incur significant search costs to locate the other, and the search requirement of connecting a buyer and a seller can be decreased, eliminated, or automated. It is further desired that transactions for personal goods or services can have their search costs lowered. It is still further desired that such systems could allow a transaction to be flexible in both costs and goods or services provided and that the system be capable of allowing a novice buyer to find goods or services with a lessened concern of being taken advantage of because they can use the system's expertise, instead of their own, in locating sellers. It is also desired that this system have some type of incentive system for encouraging the parties involved in a transaction to report information on that transaction back to the operator of the system so the operator can gather information about the types of transactions occurring, rating the buyers or sellers using the system, or to insure the system operator is compensated for his services.

The present invention discloses a method, system, and means for using a network to facilitate transactions between a buyer and at least one seller. The present invention allows buyers to send a request, a statement wherein the buyer seeks to be contacted by sellers of specific goods or services because they have a potential interest in purchasing such a good or service, to a central controller. The central controller then passes on this request to at least one seller which has indicated a desire to receive requests of certain types since they provide services or products which may correspond to what the buyer has requested. When a seller receives the request, they can choose to respond with an offer. The offer generally includes not only a dollar value they are willing to perform the service or provide the good for, but can include additional information about why they should be selected for the potential transaction. This information can be in a standardized format allowing easy reading by the buyer. Offers are sent through the central controller to the buyer who can review them and then decide with which seller or sellers they wish to have further commerce or communication to contemplate a future transaction.

The system further comprises an incentive system to improve communication between the buyer, seller and system operator to allow the operator to have information concerning when transactions take place between a buyer and a seller. This incentive system can comprise, among other things, a system whereby a reported transaction can trigger the sending of a survey to be sent to the buyer, seller, or both where they can rate the buyer or seller based on prespeciifed criteria. In other embodiments the incentive system can comprise an engine which compares the number of requests sent to a seller to the number of offers sent by that seller, or the number of offers or requests compared to the number of accepted offers that seller has received.

In still further embodiments of the invention, the buyer or seller could be given a rating. That rating could be an objective indeci of how well that buyer or seller is perceived as compared to other buyers or sellers. The indici could further be organized by the type of goods or services that the buyer or seller purchases or sells.

In a still further embodiment of the invention, a seller's rating could be used to determine internal to the system when a seller will receive a request. The system could distinguish so only a set number of the highest rated sellers receive all requests, with the requests being split amoungst other sellers by algorithm, or could have some other method for distributing the requests based on the seller's rating.

The present invention further discloses a system, method, and means as described above where the request may be sent to the seller identifying the desired product or service, price, and/or other necessary terms, but without identifying the buyer. The request can be anonymous and the buyer's identity can be concealed from the potential sellers until the buyer chooses to reveal it. In further embodiments, the anonymous request can include non-identifying data about the buyer which do not give identiy but provide useful information about such factors as geographic location, previous purchases, or other information. In one embodiment the information provided is the buyers zip code.

In this document the following terms generally have the meanings provided below, but these meanings are not intended to limit the clear scope and meaning of any of these terms as known by people skilled in the art.

‘User’ generally denotes an entity, such as a human being, using a device, such as one allowing access to a network. This is typically a computer having a keyboard, a pointing device, and a display device, with the computer running software able to display computer-originated material typically received from one or more separate computers. Preferably the user's computer is running browser software enabling it to act as a client and communicate by the Internet to one or more servers. The user can, however, be any entity connected to a network through any type of client.

‘Browser’ generally denotes, among other things, a process or system that provides the functionality of a client, such that it interconnects by a network to one or more servers. The browser may be Microsoft's Internet Explorer, Netscape's Navigator, any Active-X enabled browser, or any other commercial or custom-designed browser or any other thing allowing access to material on a network.

‘Client’ generally denotes a computer or other thing such as, but not limited to, a PDA, pager, phone, WebTV system, or any software or hardware process that interconnects by a network with one or more servers.

‘Server’ generally denotes one or more computers or similar devices that interconnect by a network with clients and that have application programs running therein, such as for the purpose of transferring computer software, data, audio, graphic and/or other similar material. A server can be a purely software based function. Server also includes any process or system for interconnecting via a network with clients.

‘Buyer’ generally denotes a user interested in the acquisition of a good or service. Although it generally refers to a user interested in a particular good or service (for example: a television), it could also refer to a user interested in a general class of goods or services (for example: second-hand electronics), or a personalized good or service. A buyer could also be a user representing a company, agency, association, or any other entity, either in an employee, agency, contractor or any other relationship seeking to acquire goods or services for the benefit of that entity. A buyer could also be an automated process seeking to acquire specific goods or services. A buyer can also be a seller in a different transaction, or a different part of the same transaction.

‘Seller’ generally denotes a user interested in providing goods or services in exchange for value. A seller will generally be a commercial entity seeking to exchange goods or services for currency or monetary instruments, but it could also be any user seeking to sell goods or services, or exchange goods or services for other goods or services. A seller need not be commercial or for profit. A seller includes users seeking to solicit donations to charitable causes, or seeking investment opportunities. A seller could also be a user representing a company, agency, association, or any other entity, either in an employee, agency, contractor or any other relationship seeking to provide goods or services to potential buyers for the benefit of that entity. A seller can alternatively be an automated process such as, but not limited to, an automated sales program. A seller can also be a buyer in a different transaction, or a different part of the same transaction.

‘Budget’ generally denotes a value that a buyer is willing to pay for goods or services, or a seller is willing to accept for the provision of goods or services. A budget will usually be, but is not limited to, a numerical amount of currency, an offer for trade or barter, a financial instrument, or any other item which could potentially have value to either the buyer, the seller, or both.

‘Interface’ generally refers to any device, system, apparatus, method or means for getting information from a user onto the network. An interface may be software on a client, hardware on a client, physically attached to a client, on the network, or completely separate from the client. An interface can be any type of digital interface such as, but not limited to, a software process for the entry of data, a hardware process for the entry of data, a digital imaging device such as a digital camera or a scanner, a keyboard or other device allowing the user to interact directly or indirectly with the network, or any other type of digital device for getting information on the network. Alternatively, an interface can be any non-digital method for getting data on the network such as an analog signal. An interface can also be any combination of digital and non-digital processes which eventually result in the data being present on the network. These include, but are not limited to, a system whereby the data is provided to another human for entry onto the network, or an analog to digital converter.

“Operator” generally denotes an entity including but not limited to, a human being, a non-human animal, a computer-based process (such as an intelligent engine), a corporation, a business entity, or any other entity that generally has at least a modicum of control of a system for connecting buyers and sellers. This entity will usually control the system for profit, but need not do so. The operator may, but need not, operate the system, own the system, have a business interest in the system, have any type of monetary or non-monetary interest in the system, or merely be interested in the operation of the system.

### BRIEF DESCRIPTION OF DRAWINGS

FIG. 1 is a high-level diagram of the layout of one embodiment of the invention.

FIG. 2 is an example of a webpage form which could be used to enter a request. The form has been filled out with a sample request.

FIG. 3 is a flowchart describing a method to process a request through a central controller.

FIG. 4 is a flowchart describing potential processing after the request is supplied to the seller.

FIG. 5 is a functional block diagram of one system for providing a rating system for transaction participants.

### DETAILED DESCRIPTION OF THE PREFERRED EMBODIMENT(S)

As one embodiment of the subject invention, the following descriptions and examples are discussed primarily in terms of the method executing over the World Wide Web utilizing Internet software executing within a browser and C++ software executing in a server. Alternatively, the present invention may be implemented by Active-X, Java, C++, other custom software schemes, telecommunications and database designs, or any of the previous in any combination. The system can also be implemented on any type of network including the Internet, the World Wide Web, an intranet or extranet system, or any other type of network recognized by those skilled in the art existing now or in the future. In one embodiment, the invention and its various aspects apply typically to the user of a personal computer equipped with visual graphic display, keyboard, mouse, and optionally audio speakers, and equipped with browser software and functioning as an Internet World Wide Web client. However, alternative embodiments will occur to those skilled in the art, and all such alternate implementations are included in the invention as described herein.

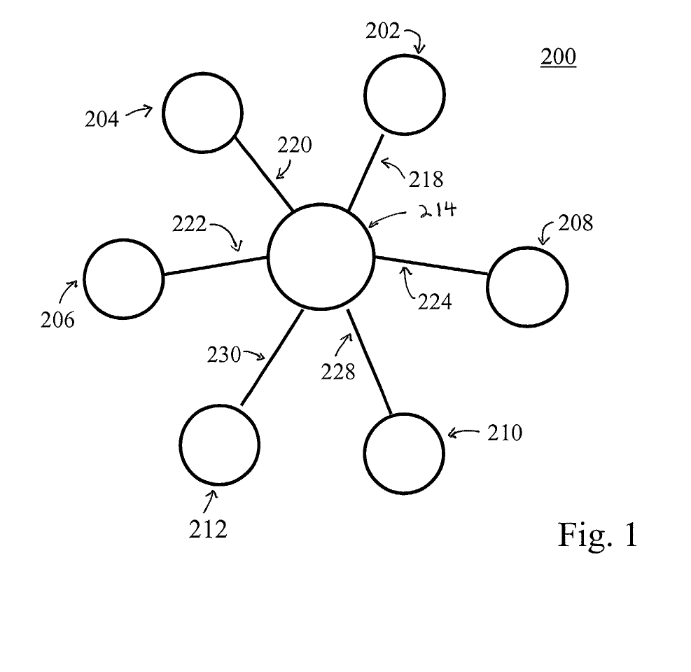

The invention comprises a method, system, and means for using a network to facilitate transactions between a buyer and at least one seller. FIG. 1 shows one potential layout of one embodiment of the invention. Buyers generate a request at an interface in any form that can be carried on the network (200). In FIG. 1, three such interfaces are shown. A webpage form (202) displayed on the client is given as one possible interface, an email request sent from the user (204) is second, and a paper request scanned into the network by a third party (206) is the third. These are by no means the only types of interface and others will be readily apparent to those skilled in the art. Once the request has been placed on the network (200) it travels to the central controller (214). The central controller (214) is a central clearinghouse for requests and offers on the network and will be discussed in more detail below. At the central controller (214) the request is reviewed and possibly modified and is then sent out to a selection of points where a seller has access to the request. These are called access points and the central controller (214) determines as at least part of its task which requests to send to which access points. An access point can have any kind of interface. There are three access points shown in FIG. 1. A webpage access (208), an email access (210) and a non-electronic access (212). These access points all have different qualities. In the webpage access (208) the seller can log on to a webpage where all requests selected by the central controller for that seller are posted so that the seller can review them at its leisure. In the email access (210) an electronic mail message is sent to an address previously designated by the seller (for example a seller's URL) so that they receive instant notification of the request and do not need to log onto a webpage. In the nonelectronic system, the central controller processes the request into a non-electronic form (for example a U.S. postal letter) and provides that to the seller through conventional channels. This way the seller does not even need to be connected to the network during the lifetime of the request in order to be able to use the network to receive specific requests. These are not the only types of interfaces available for access points and additional choices will be readily apparent to those skilled in the art.

As is apparent from the system described above, through the use of this invention buyers and sellers can be connected with minimal search required by either of them. The buyers enter their request for products they desire and that request is analyzed by the central controller and passed directly to a seller likely to be able to respond. Ideally, the buyer does not need to perform any search to be connected to potential sellers of the goods and services they seek. The sellers also may not have to perform any kind of search since they are placed in contact with buyers who have already expressed an interest in purchasing the goods or services they sell. Thus, this invention can minimize searching by the buyer and the seller.

It should be noted that there is still some small amount of searching that the buyer and/or seller may engage in, but the decrease in the search time and energy is reduced from that of the above described systems. In addition, the invention could, with sufficient information, eliminate the search totally and such an embodiment is included within this disclosure. The statement that there is no search should also be understood to apply to the case where the buyer is contacted by multiple sellers and the sellers by multiple buyers where either party may perform search-like functions to determine which buyer or seller to transact with. The lack of search in this disclosure refers to the ability of the buyer and seller to be contacted by a party with whom they could choose to transact without a search, even if they choose to perform a search anyway.

The request of the invention is a versatile structure comprising anything representing a statement wherein the buyer seeks to be contacted by sellers of specific goods or services because they have a potential interest in acquiring such a good or service. The request can be in any form but is often in the form of a “request for procurement” or RFP. Alternatively, the request can be a request for quotations, a request for bids, a request to purchase a good or service, or any other type of action, document, or statement that a buyer is interested in acquiring the good or service requested. The request can also be originally generated by any method known to the art so long as it is capable of being placed on the network through at least one interface.

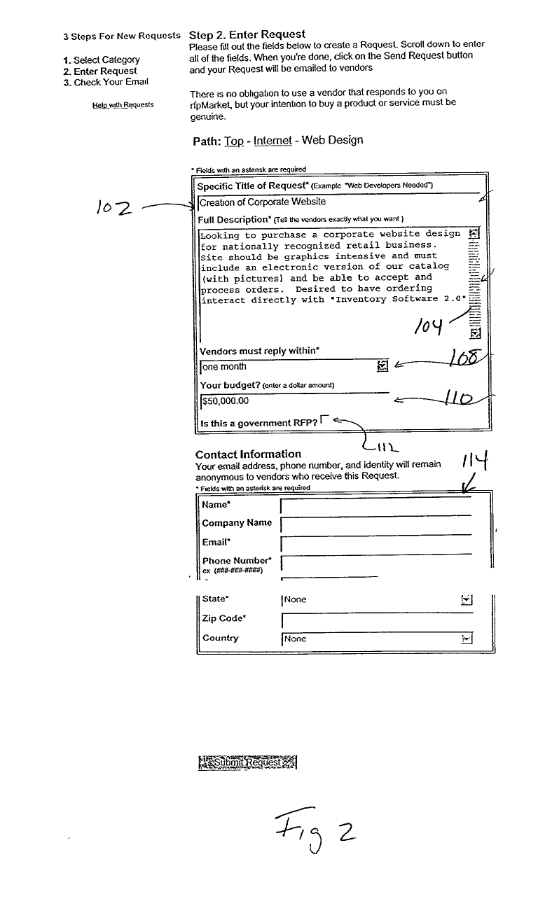

An example of a request as entered on a webpage form (202), is shown in FIG. 2. Here the request comprises a title (102) a desired service description (104), a limitation on time for response (108) and a budget (110). Whether the request is a government RFP (112) is also asked. The buyer provides a collection of personal information (114) allowing them to be uniquely associated with the request and contacted by potential sellers. In addition to allowing contact, the personal information could be used for a variety of other purposes as is known to the art including, but not limited to, tracking the individual's interests so products or services can be more readily targeted to them, or verifying the buyer's identity with a known existing person to eliminate potentially fraudulent requests.

After the request is placed on the network, it goes to the central controller (214) where the request can undergo a variety of changes, and is then selected and passed on to appropriate sellers. The central controller can be anything capable of carrying out the role of being able to receive requests from buyers on the network, processing the requests to determine sellers who could be able to provide offers based on the request, and passing on the requests to those sellers. The central controller can be, but is not limited to; a computer, multiple computers, or computer component(s); a software function; any device, apparatus, system, or means capable of connecting to the network; a semi-automated process comprising a machine connected to the network and a living organism (for example a human being); or any other device, apparatus, system, organism, method, means or combination thereof capable of fulfilling the above described role.

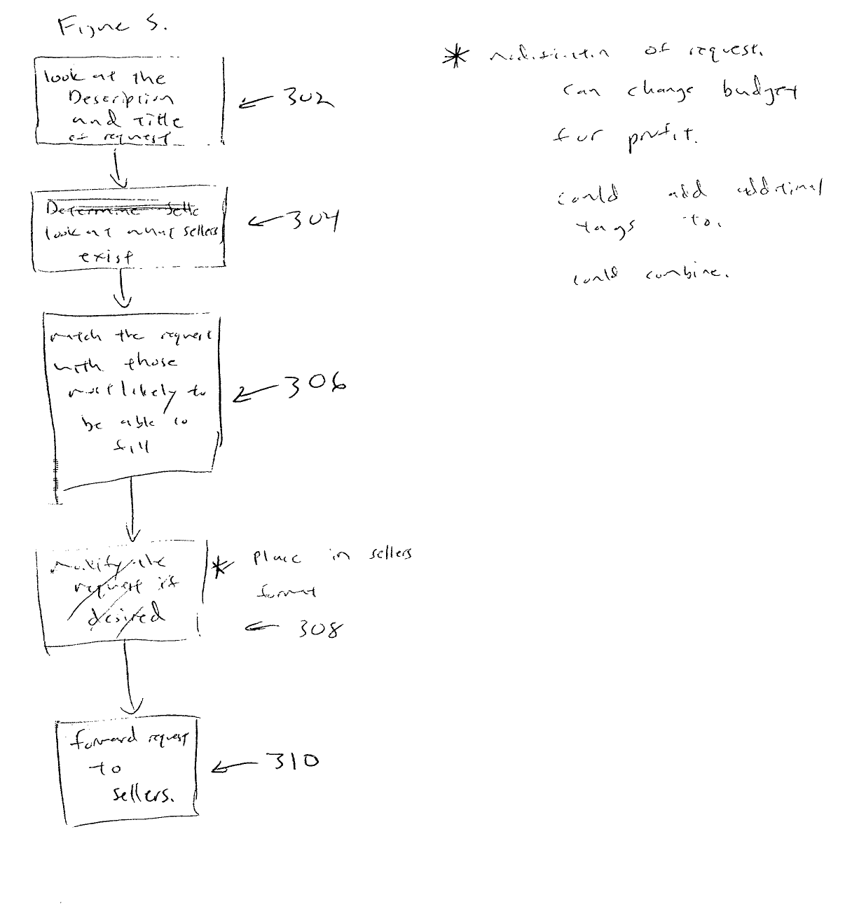

FIG. 3 shows a flowchart of a method that could be used to process a request through a central controller. First, the central controller examines the request and determines what is being sought (302). It can do this through a variety of methods including, but not limited to; evaluating the request as a whole or using specific keywords or concepts selected from the text; the buyer selecting a category to place their request in and the potential sellers being in a corresponding or matching category or those who have expressed interest in receiving requests in that category; or any other process as is known to the art being completely automated or involving interaction with a living being. After determining what is being sought in the request, the central controller (214) retrieves the sellers (304) and then determines which of the sellers would likely be interested in a particular request seeking such goods or services and whom it should forward the request to (306). The methods for selecting sellers could be any of those known to the art and the sellers could have been retrieved by any methods known to the art. In addition, any number of potential sellers could be selected including those that do not directly match the criteria (for example, the selection could be stepped so that the sellers are first selected that are closer matches, but then additional sellers are selected who progressively match the desired criteria less and less until a desired number of sellers have been selected). During this time the central controller may make changes to the request to place it in a form desired by the central controller (214) for passage to the sellers (308). These changes can comprise any number of things and can include, but are not limited to, altering the budget (110) or placing the request in a standardized form to allow the seller to more easily see desired information. After this has been done, the request is sent to the sellers' appropriate access points so that they can have access to it.

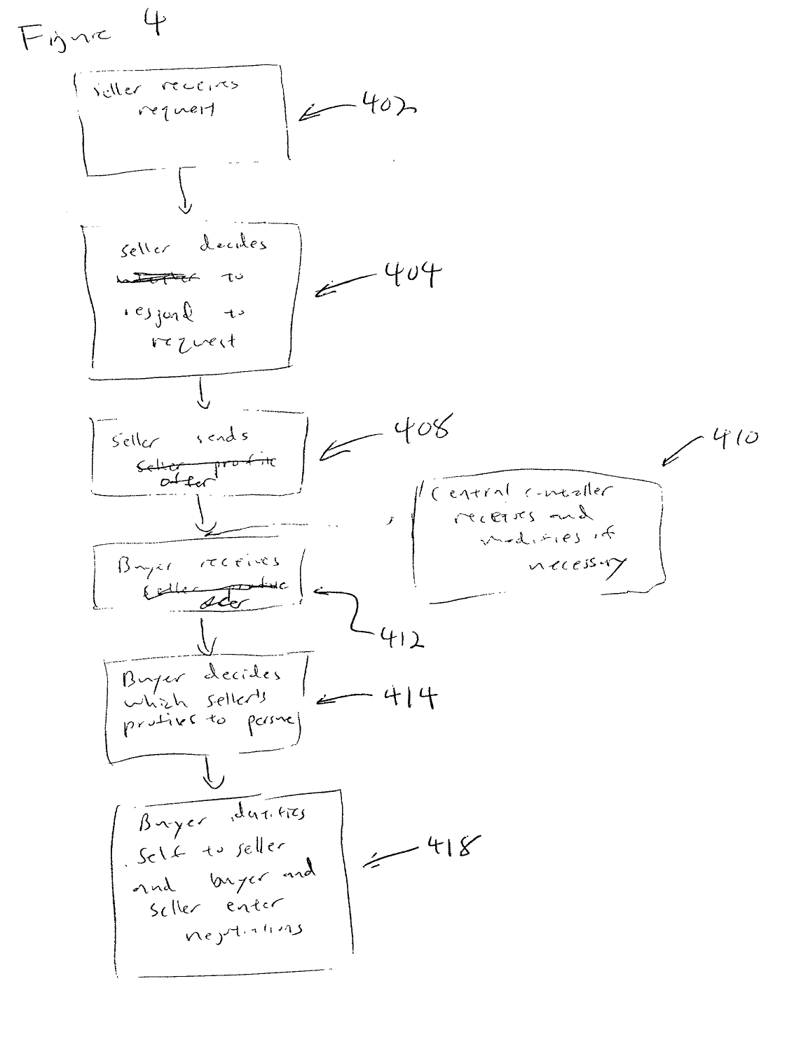

The processing after the request is sent to the seller is represented in FIG. 4. First the request is received by a group of sellers selected by the central controller (402). When a seller receives the request, they can choose to respond to the request and attempt to capture the business of the buyer (404). If the seller does not respond to the request, it is unlikely they will get the buyer's business because the buyer will not know that they are interested in the business. To respond to the request, the seller sends an offer (408) which could include not only a dollar value they are willing to perform the service or provide the good for, but a description of the type of work they do and their ability to perform the work requested in the request, as well as any other information they think would be beneficial to the buyer in determining whether to select their product or service over other potential sellers. This information can be in a standardized format allowing easy reading by the buyer. The offers are passed through the central controller which may modify the seller's offer (for instance to correspond to a pricing scheme like that described below) (410) and the central controller passes the offer on to the buyer. Once the buyer receives the sellers' offers (412), the buyer can review all the offers and select sellers whom they would like to transact for the goods or services (414). This could be any number of the sellers who provided offers and the buyer may wish to negotiate further for a better price or additional goods or services. Once the buyer has determined which sellers to contact, the buyer can enter into negotiations about terms of the transaction (418).

In another embodiment of the instant invention, the system, method and means described above further includes the ability of the buyer to remain anonymous until the seller has responded to the request. Anonymity can be very useful for the both the buyer and seller for numerous reasons. For the buyer, anonymity can be used to protect from potential price gouging. Since the seller has no idea who the buyer is, the seller cannot charge a large corporation more able to pay higher rates a higher rate than a poor individual. The offer they make must be competitive. In addition, the anonymity protects the buyer because they do not need to reveal personal information to the seller. This is a concern that has proven to be of great interest to many Internet users. They are generally reluctant to give out personal information, and can go to great lengths to preserve their privacy. By allowing the buyer to be anonymous until they desire to reveal their identity, a buyer can feel more comfortable transacting over a network. They can also be assured that companies whose offers they do not accept cannot question them on their motives or attempt to change their mind. Those sellers also cannot use the request information for targeted advertising or similar activities.

The invention can be created in a further embodiment so that the only party with access to a buyer's personal information is the central controller. The central controller can then be an uncaring “middleman” allowing for this personal information to not be transferred to anyone but those who supply the desired good or service. In addition, the central controller can be set up to not retain contact information after a certain period of time allowing the buyer's identity to not be revealed until the buyer chooses to reveal it to a potential seller. Such a private system could allow a buyer to request goods or services which they may find embarrassing or controversial without having to reveal to anyone but the purveyor of those goods or services that they are interested in acquiring them. This is beneficial because it allows buyer's seeking these goods or services to feel more comfortable shopping around for them and can eliminate stigma from their purchase. In addition, since the system can eliminate the search, it may allow users to locate items they would have been embarrassed or afraid to search for.

Sellers also have benefits from the anonymity in that it creates a more economically efficient transaction and can prevent opportunistic behavior on the part of other sellers. If the buyer was not anonymous, strategic offering behavior may occur by sellers (for instance, a particular seller may offer a purposefully low bid to win a certain request to be able to have the buyer as a potential future client). Such actions result in inefficient transfers for sellers because they must research potential buyers (as well as their competing sellers) before making their offer. Instead, since the potential buyer is anonymous, each seller must make offers more reasonably associated with the actual cost of performing the service. Sellers are also protected by anonymity since other sellers cannot contact the buyer to find out what their winning offer was or why they selected a particular seller. This allows the sellers to keep pricing and other potential competitive advantages away from their competition. They can also keep their customer lists private to prevent their competition from seeking out those who have purchased from them using the invention.

Another embodiment of the present invention allows small amounts of buyer information to be passed on to a seller while still maintaining the buyers anonymity. Reasons for this should be clear. Many products or services that can be provided may be geographically limited. For instance if a buyer requested wedding consultant services, it would be helpful for the seller to know the general location of the wedding as wedding consultants in that general location would probably be able to provide different services, at different costs than those outside the area. Information such as the geographical information could easily be passed directly from contact information provided to the central controller as part of the request, or could be separately requested by the central controller if the central controller determined that this particular request was of a type where that information would be appropriate. Geographically, information could be provided with such things as the state, the city, or the zip code entered by the buyer. Alternatively, the central controller could use information provided by the buyer to generate a result. For instance, a buyer who entered a hometown of “Alston, Mass.” which is a suburb of Boston could be reported to sellers as being “Boston Area.”

It would be readily apparent that this limited providing of information need not be limited geographically. Alternatively, information could be given about a buyers position in a purchasing company, or a desire to purchase from minority owned businesses, or any other preference of the buyer which could potentially result in a more accurate bidding by sellers on how much the buyer was worth to them.

As part of this limited information disclosure, the central controller can also access the incentive system for buyers in order to pass along gathered information about a seller. For instance, if a buyer has purchased numerous times through the system and has regularly paid their bills as reported by other sellers, a positive rating could be provided along with the request to the seller. This would allow those buyers who are easy to do business with to potentially get better offers as sellers can see they are good to transact with and represent less risk. At the same time, buyers who have backed out of transactions at the last minute or who have failed to pay bills could receive negative ratings that are passed on to sellers warning them that dealing with this buyer may have a greater risk.

Further, information about the habits of a buyer could be gathered by the central controller and passed along to the sellers. For instance, if the buyer has posted a significant number of requests, but has not reported the finalization of many transactions, this information could be valuable to a potential seller in deciding what offer to make.

In yet another embodiment, preferences of the buyer could be used as a criteria in selecting potential sellers. For instance, if a buyer always takes the lowest offer (which could be known to the central controller but probably not the sellers) the central controller could send the request to those sellers that traditionally offer more bare bones goods or services at a lower cost. Alternatively, if a buyer tends to purchase from a particular seller, the central controller can insure that seller receives the request.

As part of this information gathering system. It is desired that there be some form of system in place for gathering the information about buyers. At the same time, it could be further desirable to gather information about sellers and pass that information on to buyers, or to use that information to determine which sellers should receive certain types of requests.

Much of this information can be gathered automatically by the central controller when it handles requests or offers. For instance, the number of requests a buyer has placed, the number of offers a seller has made, or the number of offers that generally come in for a request of a particular type can all be recorded by the central controller and used for these purposes. This type of method is used in one embodiment of the incentive system. In this embodiment the incentive system is more implied than known, that is sellers and buyers are encouraged to respond appropriately because that information may or may not be recorded and they want themselves or their organizations to be shown positively.

In an alternative embodiment of the invention it may be desirable for the central controller to have access to information which is not as directly obtainable by the central controller. An examination of the above schema should show that it is possible that the central controller could be unable to obtain knowledge about a final transaction. To show an example, a buyer could send a request, and receive offers. The buyer could then contact the seller directly (i.e. by telephone) and the buyer and seller could arrange a transaction without ever going through the system disclosed. Such a transaction could be negative to the operator of the system for a few reasons. One of these is that the operator is denied information about the success rate of its services because it does not have correct numbers of transactions that have resulted from requests originally posted, and, on a more economic note, the operator may be unable to collect payment for the services he provided in connecting the buyer and the seller because he does not know that a transaction has occurred and it may be desirable for him only to charge buyers or sellers when a transaction has occurred.

To get around these problems it is desirable to create a system that encourages buyers and sellers to report transactions they have entered into back to the central controller so that the central controller can record data about either the buyer, the seller, both, or the transaction generally and to insure that the operator of the system can receive payment, if appropriate, based on the transaction.

This incentive system can take many forms and some embodiments will be discussed below. It would be recognized by one of skill in the art, however, that other types of incentive systems could be used and there are many ways to encourage an entity to provide you with information.

In one embodiment, the incentive system would comprise a rating system whereby when a transaction gets reported a numerical or other set indicia of the rating of the performance of a buyer or seller could be reported. The incentive system could then use these indicia for a variety of purposes. The indicia could be supplied with each request or offer so that either the buyer or seller has an indication of how well a buyer or seller has provided previously. In one embodiment the indicia comprises a number on a numerical scale (for instance from 1 to 10, 1 being very poor service, 10 being excellent service and 5 being average service) Every time a transaction is reported, either the buyer, the seller, or both would be asked, through any known method of requesting information to rate the other party on their performance in this transaction. As additional ratings come in, the numbers can be averaged together to provide a general indication of satisfaction, or the numbers could be provided in a list or other form allowing a potential transactor to see not only an indication of the performance, but also a number of times the transactor has had high or low performance.

In an alternative rating system, a more general rating such as satisfied or unsatisfied could be maintained with a record showing the number of transactors either satisf9ied or unsatisfied with the performance of a particular transactor.

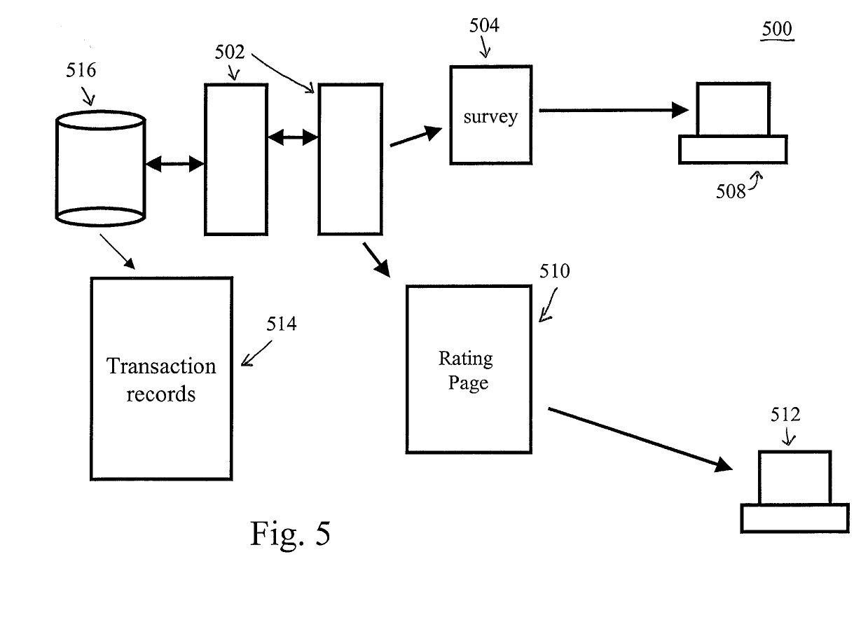

In one particular embodiment, the rating system is implemented as an application program operating on a server that comunicates with a web server, such as a conventional web server comprising an apache web server supported by a data processing platform, such as a Sun server operating the Solaris operating system. One such system is depicted in FIG. 5, which shows a system 500 that includes a server platform 502 having an application server and web server 502 and a database system 516. FIG. 5 further depicts a survey page 504, a participant system, such as a vendor 508, a rating page 510, a transaction record 514 and a perspective participant 512.

The server platform 502 may include an application program that can be, for example, a cold fusion program, that can generate, in response to an identified transaction, a survey form. The survey form may be a conventional HTML form, a java applet, a paper form, a voice response application, or any other suitable device for collecting input about the transaction from any party that may have been involved or otherwise know about the transaction, including any of the techniques described in Graham, HTML Sourcebook, Wiley Computer Publishing (1997) the teachings of which are herein incorporated by reference. In the example of FIG. 5, the application program executing on the platform 502 generates a survey upon detecting that information about a proposal has been exchanged between a buyer and seller. Upon detecting this event, the program may generate the depicted survey form 504, discussed above. The survey form in this example, can request that the seller confirm whether a deal was consumated, and optionally if it was completed, between the seller and buyer. The vendor 508 completes the form, indicating this information, and any other information requested on the form, and the form is returned. The form may be returned directly to the platform 502, to a third party service that analyzes and/or audits survey results, or to another suitable party. Optionally, a similar form may go to the seller, or to another party, such as a middleman, agent of broker for one of the participants.

In any case, once the survey form is completed, the application program on platform 502 can process the information, as discussed above, to generate a rating for the vendor, seller, broker, all of these parties, or any other party that took part in this process. The rating page 510 is a conventional HTML page, and may include information such as the overall rating, the category that the rating applies to, the overall number of completed transactions, average characteristics of the transcation, such as time, cost, quality, and other such factors. In the practice depicted in FIG. 5, the information is employed to create the ratings page 510, that indicates a rating for the respective participant. Thus, continuing with this example, if a vendor continually successfully closes on transactions started on this network, then the vendor may be given a very high rating, indicating that the marketplace has selected this vendor as a successful, and experienced participant.

Additionally, as shown in FIG. 5, the information about a closed transaction may be employed for creating a transaction record. The tranasaction record may indicate that a transaction, for value, has been completed and that an invoice is to be sent, if not sent already, to the participant in the transaction, such as the vendor, that agreed to pay the RFP network a portion of the overall transaction price, or other fee.

To leave rating systems, and examine alternative types of incentive systems, transactors could be asked for a brief description of the transaction and their experience with the transactor. These could then be published or made available to buyer and sellers. Or they could be summarized into important keywords, or any other method as would be known in the art.

In addition, the incentive system could relate to benefits for a particular transaction. For instance, when a transaction occurs a seller may be provided with free advertising, such as space on a systems advertising banner (such banners being well known to the art) or being advertised directly on a home page or other component of the system.

The incentive system could also directly relate to provided benefits or perks. For instance a seller could be provided with discounted fees after reporting so many transactions in a given time period, or a buyer could receive free goods or services from a seller selected by the central controller after so many transactions. In yet a further embodiment, frequent buyers or sellers could receive premium levels of service from the service provider. Perhaps allowing additional customizable features, or allowing them a higher level access (such as to “pre-review” offers or requests before the system actually sends them out).

It should be clear to the reader that there are many types of incentive systems and all of those incentive systems are included within the scope of this disclosure. In addition, as additional incentive systems are created, it should be clear that these new system could be implemented on the system for connecting buyers and sellers and are also included within the scope of this invention.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

1. A system to facilitate transactions on a network between a buyer and at least one seller comprising:
at least one interface where said buyer can place on said network a request which includes possible terms of sale;
at least one access point where said at least one seller can access and respond to said request with at least one offer;
a central controller providing for the transfer of offers and requests between said buyer and said at least one seller and;
an incentive program;
whereby said buyer receives at least one of said at least one offer from at least one of said at least one seller and can select any of said at least one of said at least one seller to enter into a transaction with, said seller and/or said buyer desiring to report said transaction because of said incentive program.

2. The system of claim 1 wherein said incentive program comprises a survey provided to at least one of said buyer and said seller whereby said at least one said buyer and said seller can provide feedback based on parties involved in said transaction.

3. The system of claim 2 wherein said survey includes predetermined criteria.

4. The system of claim 1 wherein said incentive system comprises providing a rating for the buyer or seller.

5. The system of claim 4 wherein said rating is based on the number of successful transactions the buyer or seller has been involved in.

6. The system of claim 4 wherein said rating is based on the number of unsuccessful transactions the buyer or seller has been involved in.

7. The system of claim 4 wherein said rating is based on the number of requests provided to a seller.

8. A central controller comprising:
a means for receiving requests from buyers on a network;
a means for receiving offers from sellers;
a means for transferring said requests to said sellers and said offers to said buyers and;
incentive program means;
whereby said buyers can select any of said sellers to have a transaction with and at least one of said buyers and said sellers desires to report said transaction to said central controller because of said incentive program means.

9. A method of doing business comprising:
receiving a request on a network from a buyer;
processing said request to determine what it is seeking;
forwarding said request to at least one seller based on what said request is seeking;
receiving at least one offer from said at least one seller;
sending at least one of said at least one offer to said buyer;
allowing said buyer to select any of said at least one seller to transact with.

10. The business method of claim 9 further comprising:
modifying said request before forwarding said request to said at least one seller and;
modifying at least one of said at least one offer before sending at least one of said at least one offer to said buyer.

11. The business method of claim 10 wherein said modifying corresponds to a pricing scheme.
